(19) United States
(12) Patent Application Publication
(10) Pub. No.: US 2003/0151591 A1
(43) Pub. Date: Aug. 14, 2003

(54) Weather data delivery system

(76) Inventors: James M. Harpen, Toledo, OH (US); John T. Zalewski, Perrysburg, OH (US); Daniel J. Sadoski, Perrysburg, OH (US); David Gorka, Perrysburg, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/353,655

(22) Filed: Jan. 29, 2003

Related U.S. Application Data
(60) Provisional application No. 60/356,028, filed on Feb. 11, 2002.

(51) Int. Cl. G09G 5/00

(52) U.S. Cl. 345/156

(57) ABSTRACT

An apparatus and method for providing a weather information display includes a data receive and conditioning server for enhancing, compressing, encrypting and storing weather data specific to at least one area; and a distribution server for delivering the stored weather data to an Internet connection. A client utilizes a data send and receive module to request and receive the stored weather data specific to the at least one area and a display application to display the associated weather data as an overlay on an electronic navigation display. The displayed associated weather data can be at least one of Doppler weather radar images, wind and wave conditions, lightning strikes, surface water temperature, tides, air temperature, storm track, satellite images, short-term forecast, long-term forecast, and precipitation totals. The data send and receive module and the display application are software adapted to run on a general purpose computer and can be adapted to proprietary electronic navigation systems.

### CROSS-REFERENCE TO RELATED APPLICATION

This application claims the benefit of U.S. provisional patent application serial No. 60/356,028 filed Feb. 11, 2002.

### BACKGROUND OF THE INVENTION

The present invention relates generally to an apparatus and method for delivering comprehensive weather data to users.

Accurate, timely local weather information is important to many persons whose occupations or recreational activities are outdoors. One source of such weather information is the National Weather Service, operated by the National Oceanic and Atmospheric Administration (NOAA). The National Weather Services has a network of weather observation stations that collect and radio broadcast local weather data.

The U.S. Pat. No. 6,181,324 shows a portable read-only device for displaying real-time weather information obtained by a cellular telephone, land line or other communication means. The device is used as a substitute for satellite-fed desktop weather stations and/or desktop or laptop computer weather stations. A remote weather server provides various types of weather information such as radar images, lightening detection, tides, temperature, storm track, satellite images, short-term forecast, long-term forecast, and precipitation totals. The device provides an audible warning to signal NOAA weather alerts and has a SVGA color touch-sensitive display permitting hand selection of the type of weather information displayed.

The U.S. Pat. No. 6,297,766 shows a portable weather indicating device including a GPS (global positioning system) to determine the user's location. Weather data is received from one or more base stations at different locations. Each base station obtains real-time or near real-time weather data from one or more sources. Examples of such weather information sources are radar signals from the Next Generation Weather Radar (NEXRAD), satellite signals from the National Oceanic and Atmospheric Administration (NOAA) satellite systems and the NOAAPORT Broadcast System (NBS).

### SUMMARY OF THE INVENTION

The present invention concerns a method for providing a weather information display comprising the steps of: a) providing a first server responsive to weather data specific to at least one area, the weather data being transmitted from a source of weather data; b) operating the first server means to generate compressed and encrypted weather data from the weather data specific to at least one area; c) providing a second server to store the compressed and encrypted weather data and connecting an input/output port of the second server to the Internet; d) providing a client side data send and receive module having a module input/output port and a module input/output, and connecting the module input/output port to the Internet; e) providing a client side display application having an application input/output, and connecting the application input/output to the module input/output; and f) operating the module and the application to obtain the compressed and encrypted weather data from the second server and display the weather data. The method includes performing the step a. by connecting the first server to a NOAA server and/or other raw weather data source to receive the weather data specific to at least one area.

The method also includes operating the first server to enhance the weather data prior to performing the step b. Performing the step f. includes generating setup and configuration signals from the module to the application, generating a weather data request from the application to the module, generating uncompressed weather data from the module to the application, generating a module data request from the module to the second server and generating the compressed and encrypted weather data from the second server to the module.

The step a. can be performed by providing the first server as a data receive and conditioning server and the step c. can be performed by providing the second server as the at least one data distribution server, the data receive and conditioning server compressing and encrypting the weather data specific to at least one area and the at least one data distribution server storing the compressed and encrypted weather data. The steps c. and d. can be performed by connecting the second server and the module to a low bandwidth Internet connection.

The present invention also concerns a system for providing a weather information display comprising: a server means responsive to weather data received from a source of weather data for generating and storing compressed and encrypted weather data specific to at least one area; and a client display means responsive to said compressed and encrypted weather data specific to at least one area for displaying associated weather data in response to a request by a client, said client display means generating said client request to said server means, said server means being responsive to said client request for transmitting the stored compressed and encrypted weather data to said client display means. The server means can include a data receive and conditioning server adapted to be connected to the source of weather data and a data distribution server connected to the data receive and conditioning server and adapted to be connected to the client display means through an Internet connection. The display means can include a client side data send and receive module adapted to be connected to the Internet for receiving the stored compressed and encrypted weather data from the server means and generating uncompressed weather data; and a client side display application means connected to the module for requesting weather information and for receiving the uncompressed weather data for display. The displayed associated weather data can be at least one of Doppler weather radar images, wind and wave conditions, lightning strikes, surface water temperature, tides, air temperature, storm track, satellite images, short-term forecast, long-term forecast, and precipitation totals. The system client display means includes software adapted to run on a microprocessor including a general purpose computer and the software includes a data send and receive module and a display application.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic block diagram view of the weather data delivery system in accordance with the present invention.

### DESCRIPTION OF THE PREFERRED EMBODIMENT

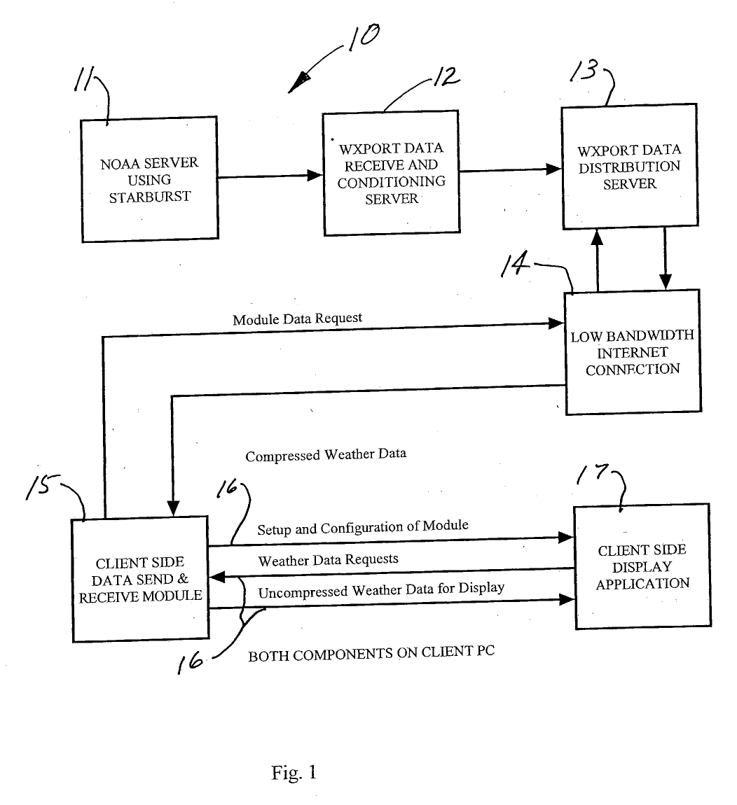

FIG. 1 is a schematic block diagram showing the hardware connections and data flow for the weather data delivery system and method according to the present invention. A weather data system 10 according to the present invention includes a NOAA server 11 using the Starburst™ software and/or other source of raw weather data. The National Weather Service (NWS) requires the use of the Starburst receiver software, which software is available for downloading from the NWS, to receive the weather data generated by NWS. The receiver software will be: “OmniCast™ Advanced Receiver” Ver. 1.7.5 for operating systems NT, AIX, or Sun Solaris; or receiving software provided in the specific package selected at download based upon the “Receiving Platform” of choice from a list provided; or receiving software written for the server 11.

According to the present invention, to a Weatherport (WXPORT) data receive and conditioning server 12 receives the weather data from the NOAA server 11 via any suitable connection to an input of the server. Typical weather data can include, but is not limited to, Doppler weather radar images, wind and wave conditions, lightning strikes, surface water temperature, tides, air temperature, storm track, satellite images, short-term forecast, long-term forecast, and precipitation totals. The data received from the NOAA server 11 can be enhanced through a computer program running on the server 12 creating the data ultimately received by the client. That enhanced data is then digitally compressed and encrypted. The data receive and conditioning server 12 has an output at which it sends the compressed and encrypted data to a connected input of a Weatherport WXPORT data distribution server 13 having an input/output port connected to the Internet.

Weather information clients are provided with a client side data send & receive module 15 that has an input/output port that can be connected to the Internet via a low bandwidth connection 14. The term “low bandwidth” is relative and could be, for example, some form of DSL service, cellular phone, satellite phone, or any other suitable wireless connection. The module 15 can send weather data requests to and receive the compressed weather data from the server 13 over the connection 14. The module 15 is also connected at an input/output by a data transmission path 16 to an input/output of a client side display application 17 running on a microprocessor of the type used in personal computers and GPS devices. The display application 17 sends “Setup and Configuration” instruction signals over the path 16 to initialize the module 15. Then the display application 17 sends a “Weather Data Request” signal to the module 15. The module 15 responds to the request by generating a corresponding “Module Data Request” signal to the data distribution server 13 over the Internet connection 14. The “Compressed Weather Data” associated with the specific request is sent from the server 13 to the module 15 to be uncompressed and the “Uncompressed Weather Data” is sent to the display 17.

The client side display application 17 presents the weather data as an overlay of an associated electronic navigation display such as a map or a chart. The navigation display information can be generated by the GPS device or by a database. The database information can be stored in any convenient location such as a hard drive or a CD-ROM, or can be obtained from a web site over the Internet connection 14. The weather information can include, but is not limited to, Doppler weather radar images that can be of the animated type, wind and wave conditions, lightning strikes, surface water temperature, and other related data available from both government and private organizations.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A method for providing a weather information display comprising the steps of:
a. providing a server means responsive to weather data specific to at least one area, the weather data being transmitted from a source of weather data;
b. operating the server means to generate and store compressed and encrypted weather data from the weather data specific to at least one area;
c. connecting an input/output port of the server means to the Internet;
d. providing a client side data send and receive module having a module input/output port and a module input/output, and connecting the module input/output port to the Internet;
e. providing a client side display application having an application input/output, and connecting the application input/output to the module input/output; and
f. operating the module and the application to obtain the compressed and encrypted weather data from the server means and display the weather data.

2. The method according to claim 1 including performing the step a. by connecting the server means to a NOAA server to receive the weather data specific to at least one area.

3. The method according to claim 1 including operating the server means to enhance the weather data prior to performing the step b.

4. The method according to claim 1 including performing the step f. by generating setup and configuration signals from the module to the application, generating a weather data request from the application to the module, and generating uncompressed weather data from the module to the application.

5. The method according to claim 4 including performing the step f. by generating a module data request from the module to the server means and generating the compressed and encrypted weather data from the server means to the module.

6. The method according to claim 1 including performing the step f. by displaying the weather data as an overlay on an electronic navigation display.

7. The method according to claim 1 including performing the step a. by providing the server means as a data receive and conditioning server connected to at least one data distribution server, the data receive and conditioning server compressing and encrypting the weather data specific to at least one area and the at least one data distribution server storing the compressed and encrypted weather data.

8. The method according to claim 1 including performing the steps c. and d. by connecting the server means and the module to a low bandwidth Internet connection.

9. A method for providing a weather information display comprising the steps of:
a. providing a first server responsive to weather data specific to at least one area, the weather data being transmitted from a source of weather data;
b. operating the first server means to generate compressed and encrypted weather data from the weather data specific to at least one area;
c. providing a second server to store the compressed and encrypted weather data and connecting an input/output port of the second server to the Internet;
d. providing a client side data send and receive module having a module input/output port and a module input/output, and connecting the module input/output port to the Internet;
e. providing a client side display application having an application input/output, and connecting the application input/output to the module input/output; and
f. operating the module and the application to obtain the compressed and encrypted weather data from the second server and display the weather data.

10. The method according to claim 9 including performing the step a. by connecting the first server to a NOAA server to receive the weather data specific to at least one area.

11. The method according to claim 9 including operating the first server to enhance the weather data prior to performing the step b.

12. The method according to claim 9 including performing the step f. by generating setup and configuration signals from the module to the application, generating a weather data request from the application to the module, and generating uncompressed weather data from the module to the application.

13. The method according to claim 12 including performing the step f. by generating a module data request from the module to the second server and generating the compressed and encrypted weather data from the second server to the module.

14. The method according to claim 9 including performing the step f. by displaying the weather data as an overlay on an electronic navigation display.

15. The method according to claim 9 including performing the step a. by providing the first server as a data receive and conditioning server and performing the step c. by providing the second server as an at least one data distribution server, the data receive and conditioning server compressing and encrypting the weather data specific to at least one area and the at least one data distribution server storing the compressed and encrypted weather data.

16. The method according to claim 9 including performing the steps c. and d. by connecting the second server and the module to a low bandwidth Internet connection.

17. A system for providing a weather information display comprising:
a server means responsive to weather data received from a source of weather data for generating and storing compressed and encrypted weather data specific to at least one area; and
a client display means responsive to said compressed and encrypted weather data specific to at least one area for displaying associated weather data in response to a request by a client, said client display means generating said client request to said server means, said server means being responsive to said client request for transmitting the stored compressed and encrypted weather data to said client display means.

18. The system according to claim 17 wherein said server means includes a data receive and conditioning server adapted to be connected to the source of weather data and a data distribution server connected to said data receive and conditioning server and adapted to be connected to said client display means through an Internet connection.

19. The system according to claim 17 wherein said client display means includes a client side data send and receive module adapted to be connected to the Internet for receiving the stored compressed and encrypted weather data from said server means and generating uncompressed weather data; and a client side display application means connected to said module for requesting weather information and for receiving the uncompressed weather data for display.

20. The system according to claim 17 wherein the displayed associated weather data is at least one of Doppler weather radar images, wind and wave conditions, lightning strikes, surface water temperature, tides, air temperature, storm track, satellite images, short-term forecast, long-term forecast, and precipitation totals.

21. The system according to claim 17 wherein said client display means includes software adapted to run on a general purpose computer.

22. The system according to claim 21 wherein said software includes a data send and receive module and a display application.

23. The system according to claim 17 wherein said client display means generates an electronic navigation display of the at least one area and displays the associated weather data as an overlay to the electronic navigation display.
